(19) United States
(12) Patent Application Publication
(10) Pub. No.: US 2015/0206217 A1
(43) Pub. Date: Jul. 23, 2015

(54) GARMENT AND ACCESSORIES FITTING

(71) Applicant: MYCLOZZ 6, LTD, Jerusalem (IL)

(72) Inventor: Yiftach Cohen, Jerusalem (IL)

(73) Assignee: MYCLOZZ 6, LTD, Jerusalem (IL)

(21) Appl. No.: 14/422,827

(22) PCT Filed: Aug. 20, 2013
(86) PCT No.: PCT/IL2013/050709

§ 371 Date: Feb. 20, 2015

Related U.S. Application Data
(60) Provisional application No. 61/748,273, filed on Jan. 2, 2013.
(60) Provisional application No. 61/684,833, filed on Aug. 20, 2012.

(51) Int. Cl. G06Q 30/06; G06T 1/00; G09G 5/02

(52) U.S. Cl. CPC G06Q 30/0621; G06Q 30/0643; G09G 5/02; G06T 1/0007; G06T 2207/10004; G06T 2207/30124

(57) ABSTRACT

A method for exchanging data between a buyer side and a service provider (SP) side. The buyer proposes to acquire merchandise such as a garment, and the SP retains access to a variety of pieces of merchandise for which a match between the buyer side and the SP side is to be sought. To accomplish, first an image of an existing garment together with a reference object is acquired by an imaging mobile communications system. Then the image us rectified by using data relating to the reference object. Subsequently scale is computed and a model of the garment is made. The model is sent by the interne to the SP to match with existing data base items.

### CROSS-REFERENCE TO RELATED PATENT APPLICATIONS

This application claims priority from a first provisional patent application in the U.S. No. 61/684,833 filed 20 Aug. 2012 entitled “garment and accessories fitting to customer over the internet”. This application also claims priority from a second provisional application in the U.S. No. 61/748,273 filed 2 Jan., 2013 entitled “method for digitally measuring articles”.

### TECHNICAL FIELD OF THE INVENTION

The present invention is in the field of commerce, and specifically relates to acquiring goods in a process associated with selecting in accordance with the purchasing needs.

### BACKGROUND OF THE INVENTION

Merchandise selection and purchase over the internet has become a most common shopping alternative for customers. In some cases notably for garments, shoes, jewelry, etc. it is essential that the buyer sends data relating his/her body or other garments in his/her possession. The present invention deals with a method for obtaining such measurements which can be sent to the provider for fitting clothes to the dimensions. In addition to garments, the same methods of the invention can be sued to match requests of buyers to vendors of jewelry rings, shoes, bracelets or any other element applied to the body which requires measurement in order to be practically applicable. Such ornaments or minor items will be referred to herein after as “accessories”.

### BRIEF DESCRIPTION OF THE FIGURES

FIG. 1 is a schematic description of the general framework in which the present invention is implemented.

FIG. 2 is a schematic side view of a camera and reference object relationships.

FIG. 3 is a schematic front view of a reference object demonstrating a screen and an embedded screen image.

FIGS. 4A-D represent different aspects of reference object with respect to a camera.

FIG. 5 is a chart showing flow of events as accomplished in a session of measurement of body dimensions in accordance with the invention,

FIG. 6A is an exemplary event flow diagram showing main points of acquired image of a reference object and its rectification.

FIG. 6B is an event flow diagram showing an exemplary dimension correction (rectification) methodology using parameters of the reference object as accomplished with reference to FIG. 6A.

FIG. 7 is an event flow diagram showing the color definition procedure and data exchange between the two portable communications devices used in such procedure.

FIG. 8 is a block diagram schematizing the relationships between the devices implemented in accordance with the present invention in the colour calibration aspect.

FIG. 9 is a schematic description of the commercial framework in which the present invention is likely to be implemented.

### DETAILED DESCRIPTION OF EMBODIMENTS OF THE PRESENT INVENTION

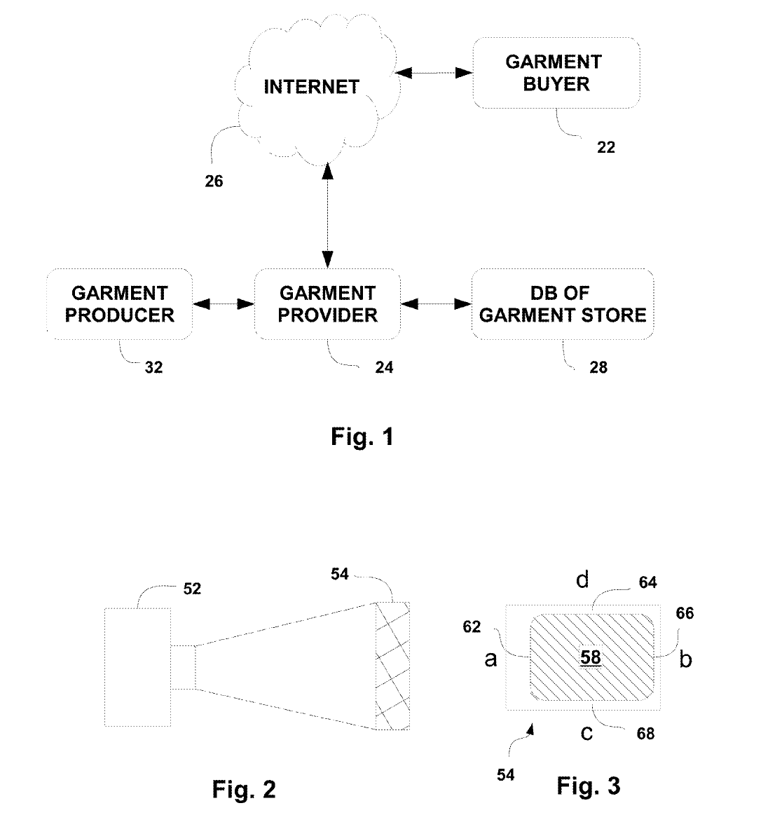

The technical framework within which present invention may be implemented as described in FIG. 1. The present invention is further exemplified and discussed with reference to the figure. Garment buyer 22, wishing to buy a garment or an accessory from a garment provider 24 finds the garment or accessory of choice displayed for example, in a website managed by the garment provider or by a third party service provider through the Internet 26. The buyer, at the buyer side, measures dimensions of regions his/her body, or retrieves data from a data base, to produces report and send it to provider 24, in addition to sending a catalog number of the selected garment. The provider, at the service provider side, then queries a relevant data base 28, to find out whether such catalogue number with matching dimensions exists. If not, producer 32 who may be also a service provider, may be commissioned to produce a fitting catalogue item as desired. The goods of the provider can be found or demonstrated through a smart-phone, tablet, personal computer or any user terminal having a graphic screen or interface. In addition to browsing a website, a user may implement an application or any other program that can fetch images from a shared data base of a service provider or provider of goods. The above scenario, in accordance with the present invention, not only relates to buyer purchaser relationships in the strict definition of the word but also to swapping scenarios, or any non commercial scenes.

The present invention deals with a technique for measuring properties of objects, typically the human wearer of garments, garments as such, shoes or other worn items at the buyer side. The technique employs a camera, notably an electronic camera typically but not exclusively of a portable communications device, for acquiring images of objects, some of which objects having a set of known properties. At least some of such properties are geometrical characteristics. There are two main aspects associated with this invention. One aspect relates to extracting geometric data from the body of a user or from clothes of a user, to create working model for facilitating the acquisition of garments in a remote location. This remote location is referred to as the service provider side, although no mandatory commercial aspect implied. Another aspect is that of extracting color definition from the buyer side (also no commercial aspect is necessarily implied), in order to match user's selection with service provider or goods provider collection.

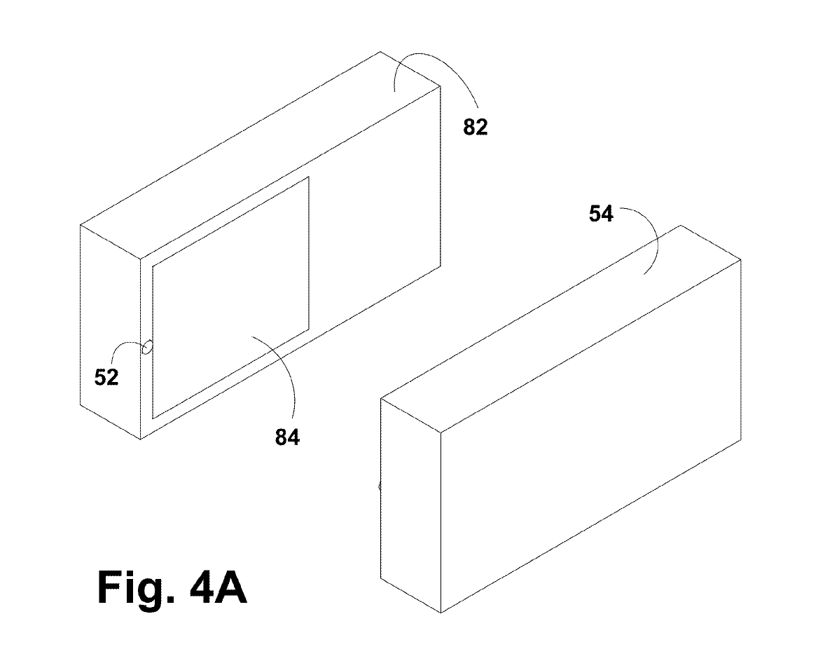

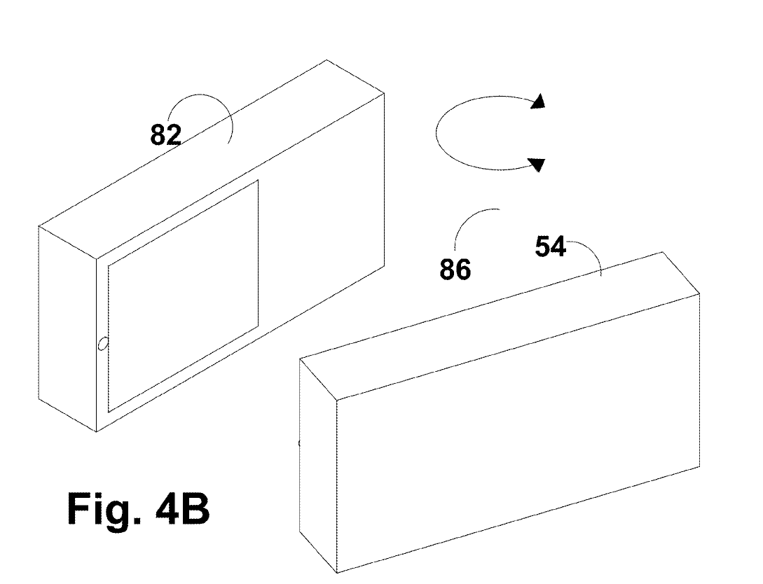

In FIG. 2, at the buyer side, camera 52 acquires image of a reference object (RO) 54 seen from the side (hatched) having known size parameters. In FIG. 3, RO 54 is now seen, at the buyer side, facing the drawing sheet. It has four external limits (a, b, c, and d, and an internally nested object 58 having four edges 62, 64, 66 and 68 so that a margin may be formed between the nested object and the external limits. If RO 54 is a hand held telephone such as a smart-phone, and object 58 is a screen, therefore since all commercially available communications systems have accessible properties both technical and geometric, which are all published by the respective producers, one may be able to acquire such properties and use them. To further elaborate on the nature and features of the RO.

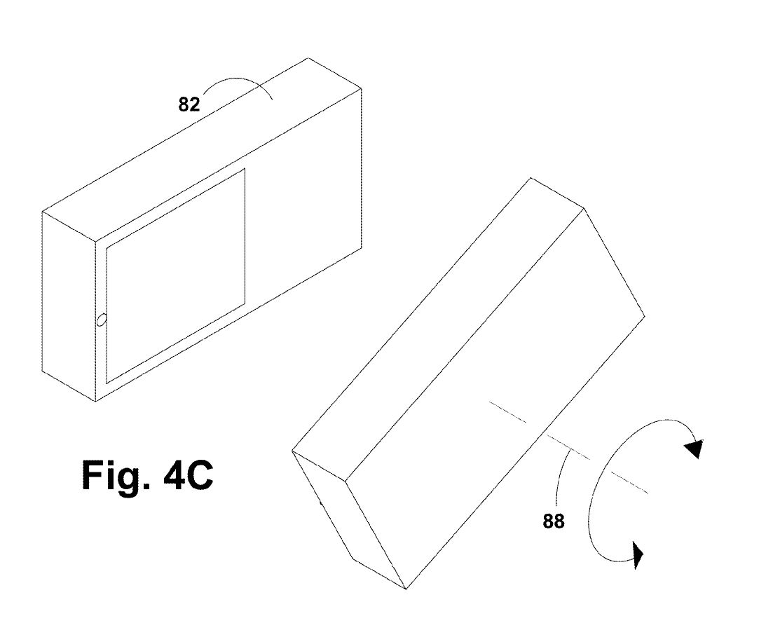

If the RO at the buyer side is a hand-held object such as a smart-phone, it may be tilted in any dimension or a combination of dimensions. In FIG. 4A, an exemplary arrangement is schematically described, camera 52 is a part of smart-phone 82, faces RO 54 which may well be the same type of camera embedded in a smart-phone, and in this case both are matching perfectly face to face, such that the screen 84 on smart-phone 82 has a matching screen on RO 54. This arrangement is not necessarily the best one to use but shown how at the simplest combination, the image acquiring device and the RO are in fact mirror image of one another. It should be mentioned that personal phones as general category, and in them smart-phones are typically equipped with more than one camera differing in quality, pixel number and size, etc. Such cameras are distributed on the back and on the front of the main body, some such personal communications devices include tilting sensor at one or more dimensions. In a typical case, the best camera (optics wise and resolution wise is installed looking forward from the face of the device in the opposite side of the user interface. In FIG. 4B the RO is rotated around imaginary axis 86 with respect to smart-phone 82, in FIG. 4C the RO is rotated with respect to axis 88 and in FIG. 4D the RO is rotated around imaginary axis 92 with respect to smart-phone 82. This discussion of axes of rotation is there to demonstrate how hand held instruments are rotatable in all axes

Exemplary Measuring Protocol in Accordance with the Present Invention

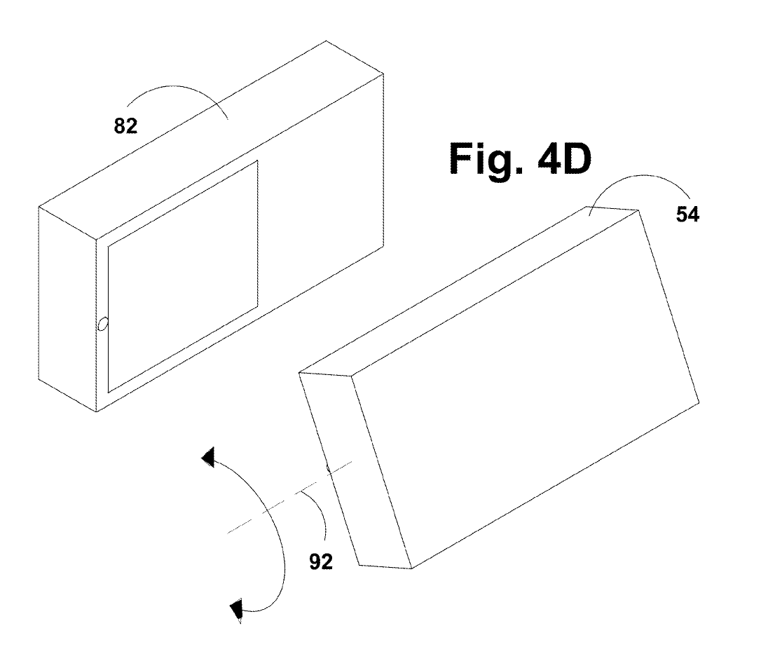

A potential buyer of a garment or accessories referred to hereinafter as “the buyer” may be assisted by an assistant, who is capable of using an electronic camera of a smart-phone. An exemplary measurement protocol of body dimensions in accordance with the present invention is described with reference to FIG. 5. At the buyer side, first, in step 120 the reference object (RO) is positioned by the buyer at a location such that tight contact with the middle of the belly is formed. The RO being in this example a smart-phone with its screen looking at the assistant who holds in turn another communications device, referred to hereinafter as the “imaging mobile communications system terminal” (IMCS), such as a smart-phone, or worn devices such as “Google glass” the camera of which faces the RO. In more general terms both the RO and the IMCS devices are each associated with a respective mobile communications system terminal. Then, at step 122, the assistant initiates the process in the IMCS, during which some details are entered as parameters such as the make and manufacturer's model of the RO, if this has not been done so automatically before. The protocol should use as much data as essential or required regarding the RO, for each relevant feature. At step 124 the IMCS and the RO perform a handshake procedure in which a communications link is established for flow of information. This handshaking described heretofore is optional and alternatives are available. At step 126 information regarding RO such as-inclination data is obtained. At step 128 a good quality image of the RO and surrounding objects, notably the buyer, is acquired by the IMCS and at step 130 distinctiveness procedure is executed in which the colors and distinctive forms on the environment of the RO are analyzed. Then, at step 132, the IMCS issues a command to the RO to change its appearance, for example paint the screen red or/and produce a letter “L” of certain size (in pixels on the screen) and colour on the screen. having acquired a new image at step 134, and optionally updated inclination parameters, the angular parameters for converting the apparent image geometry to a rectified image geometry for each axis is calculated. Typically all axes are rectified to form an ortho-rectified image, showing as if the IMCS was looking at the scene without any relative inclination. At step 136, the assistant is to repeat the stages starting from stage 128 over the same scene or to cover different parts of the body such as hands, sides, legs, feet etc. it may be necessary to obtain several images of the same scene in order to make three dimensional model of the scene. If several images are required a camera may be made to function as a video camera. One image may be sufficient. Generally, a three or two dimensional model of the entire body can be obtained, based on the dimensions of the RO or parts, typically patches of the RO. It is stressed at this point that the not only the body can be modeled by implementing the above described protocol but also garment at the buyers side. The buyer side having completed measuring the body and/or available clothes can send the model, which include also a scale factor, to the provider side or service provider (SP) side.

Another option is that the measurements are carried out without an assistant. In such a case, a virtual representation of the garment can be further used to show each individual user how the garment is to fit him/her. For example, a computerized application can be used to fit the image of the garment to the “unclothed” virtual body model of each specific user (preferably, into the same pose as when the user was wearing the garment). This would require to acquire a virtual body model for each user. Such can be prepared in advance. Alternatively, the body dimensions of the user can be obtained by photographing oneself. Therefor, the user is required to stand in front of a mirror that is large enough to reflect most of his body. This photographical procedure may be carried out as follows:
The camera is held at about the center of the body, while the screen and the camera of the mobile device face the mirror identifying the colors of the users clothes and background by using a program
displaying on the screen of the camera a reference image (e.g., a square in a predefined size) in a color that is in contrast (or that is does not appear at all) with respect to the identified colors of the clothing or/and background, thereby allowing the process to identify that displayed image in a captured image by the camera;

capturing an image of the reflected user's body which include the displayed reference image on the screen of the mobile device; and
calculating the body size of the user with reference to the reference image, the distance of the camera (i.e., the user's body) from the mirror and the tilt sensor. Corrections, also known as rectification (in the art of photogrammetry) for deviations from the strict orthogonal stature, can be achieved by applying tilt corrections as obtained by using tilt measurements of the camera, if the camera has a tilt sensor, as many mobile communications devices nowadays have. Corrections can also be achieved using information received from the image acquired. For example, by correcting the ratio between a length and a width of a known object. The issue of rectification will be discussed later on as well.

According to another aspect of the invention, the properties that are used for creating the virtual representation of the garment can be used for generating a user specific properties and inclinations database. Such a search engine can be used to efficiently browse and search garment according to their color, type, shape, figure and the like which fit in with the characteristics of the user.

It should be considered as a matter of efficiency and accuracy, to put the IMCS in a stable and leveled position so that corrections for tilting are not required. However, if the IMCS is not stabilized and/or leveled, the tilting parameters must also be taken into consideration much the same as is done with the RO. Also for the same reasoning of efficiency and accuracy, the garment/s prior to imaging are to be flattened to eliminate as much as possible creases and folds.

An alternative handshake procedure is one in which the MACS already inspects colors and forms in and around the RO and sends a command to the RO to change screen colour and or display a certain form on the screen. In such a case step 128 is more likely to provide a good result. Moreover, as mentioned above the IMCS can perform handshaking with the RO without exploiting the electronic communications specifically for that matter. This can be done with the IMCS acquiring one or more images of the RO and correcting (rectifying) the image based on known dimensions of the RO. For example if the RO is a credit card, the actual measures of the sides are universally known with certainty. Also, the ratio between the narrow flank and the wide flank are known, making the rectification in both dimensions feasible.

Reference Object (RO)

In the example described above, the RO is a smart-phone or a tablet having a communications system, in which the screen can be made to change colour appearance such as by showing a homogeneous color and/or display images such as a letter “L” having a specific color on a specific background. For that to occur, the screen to be controllable externally, the RO must include appropriate computer program or application. The reference object can be any object of a well known size, but the tilting parameters (typically the deviation in degrees from the vertical or the universal horizontal axes, whichever is relevant), are to be obtained for the image acquired at the time of actual take. In the case of smart-phone (or any phone having a screen of publicly disclosed dimensions) and means for measuring angular deviation from the vertical/horizontal axes. In the case of mobile telephones or personal computers having cameras and cellular communications facilities, the person holding the screen tends to extend the fingers over the edges, but due to existing margins between the active screen and the rim of the face of the instrument, the fingers should not cover parts of the active screen, (see FIG. 3) The RO for certain assignments can be however dumb, having no electronic circuitry but having some known geometrical properties. Some examples are given elsewhere in this disclosure. To stress a point, the RO in accordance with the present invention has a user controllable colour marking. In its simplest form the RO bears one or more patches of colors, defined physically for their colour parameters (such as RGB values). The user, in this simple form of RO may replace the patches by other patches having known colour values. If colour values are not available, The color values may be measured by a measuring system such as a calibrated camera, in order to have the color parameters of the RO controlled. As a general rule, the RO has, in any embodiment of the invention a set of known physical features, in addition to colours be they geometrical features, color and or pattern distribution of colors.

2D Modeling Vs. 3D Modeling of the Body and or Garments

In order to achieve 2D modeling the amount of data of the RO is lesser than the amount of data that need be obtained from the scene-for 3D modeling. In an embodiment of the present invention, in order to get accurate properties of the garment, such as the length and width of the garment at several regions (e.g., neck region, belly region, sleeves, etc.), the angle of the camera with respect to a reference plane on which the garment is located should be used. This is required in order to eliminate any distortion that may occur due to the non-parallel position (or non-optimal capturing angle) between the camera lens and the plane on which the garment is located. 2D modeling requires less dimension to be dealt with. If for example, the garment is parallel to the floor when the image acquisition takes place then the inclination of the camera is to be derived, such as by a tilt angle from the tilt sensor. The triangle formed between the camera (the vertex) and the garment, can be calculated using in addition or instead of the tilting angle, the camera distance from the aimed object, obtained by the autofocus mechanism, to measure the distance of the vertex from the garment. The known aperture angle of the camera can be used to calculates the base of the triangle using the other measurements including that of the RO in connection with garment-object. A special case is when the garment is laid on a plane parallel to the floor, and the image acquired from a point right above the garment, such as by using the tilt sensor of the camera, to put the camera in a plane parallel to the ground, no RO is required in this case.

A model in accordance with the present invention whether 2D or 3D includes at least a rectified image and a reference to scale. If the model is to include references for colors, their identities and distribution on the garment, these references are to be decipherable by any registered recipient of the model, and translatable by the recipient to the specific screen he/she employs, in order obtain realistic colours.

Tilting Measurement

For a given smart-phone being used as a RO, the dimensions of the screen are known. If the screen is tilted on one axis (see for example FIG. 4C), the tilt angle can be calculated as the ratio between the sides is known. To overcome this, angular positioning of the RO is obtained by the magnetometer data of the smart-phone on three dimensions, or once from the magnetometer and updates from the gyro and or accelerometer measurements after magnetometer data has been established first. To minimize variability and tilt in both the IMCS and RO, a single person may achieve stabilization of the IMCS such as a smart-phone on a tripod, or miniature computer equipped a camera (e.g. a tablet computer) while the buyer puts the RO on the floor next to him/her, preventing tilt at least on one axis.

Communications Between IMCS and RO

In order to perform a specific type of handshake (see step 124) and later steps in which tilting information is obtained from the RO, communications are to be established between the two hand held sets. Two examples are given, Blue Tooth® is a close range communications protocol suitable for the task. Another obvious option is communications through the internet, for example both RO and IMCS connect to the Internet through a Wi-Fi Internet access point/s. Cellular network communications is also available for appropriate devices. One other aspect of the exchange of data between the IMCS and the RO, is by making the RO being a smart device such as a personal communications device, is to have a symbol displayed on the RO screen, such as a barcode or a 2D barcode, such as QR code, for conveying information decipherable by the IMCS, either for the handshaking or for other data exchange while interacting. The barcode can be positioned in as specific place on the screen such that the IMCS will accept the data without further calculation the position.

Selecting Pair Members Among a Plurality of Available Pairing Options.

When there are several available RO in close vicinity to a IMCS, such as in a store in which several users are each implementing personal communications systems with Wi-Fi access, the IMCS, used by a specific user can issue a command for the sough—after RO to issue a certain visible cue on its screen.

Calculating Body Dimensions Using Parameters from the Measuring Protocol

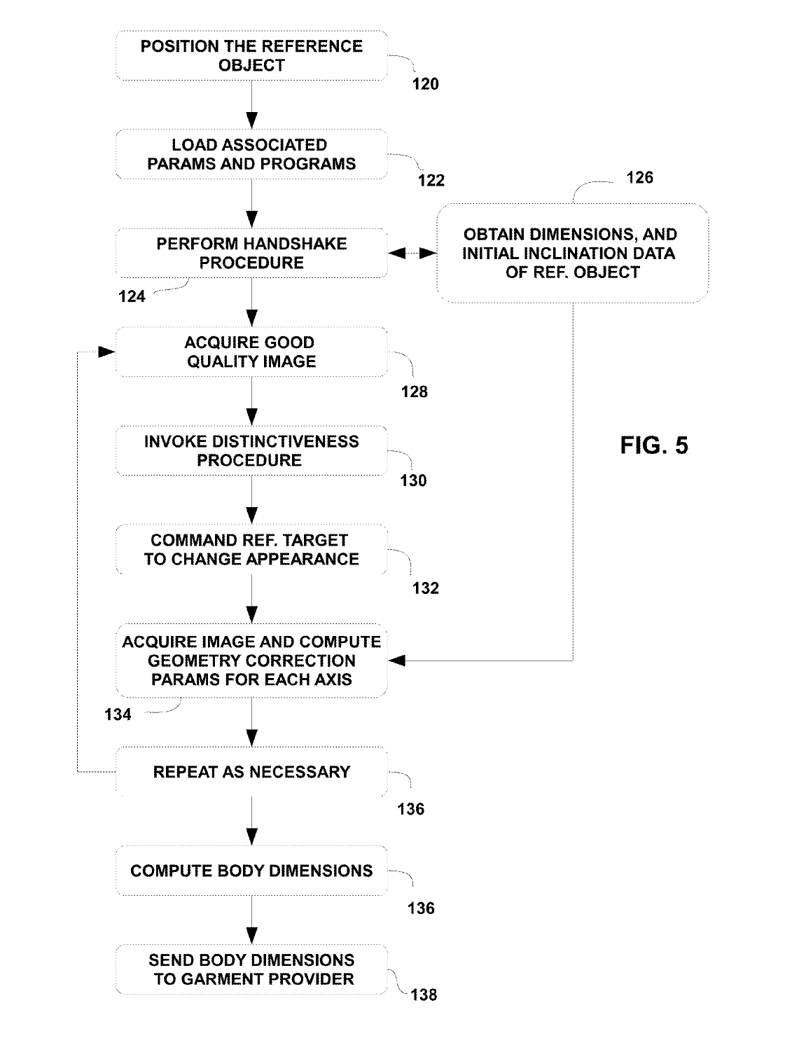

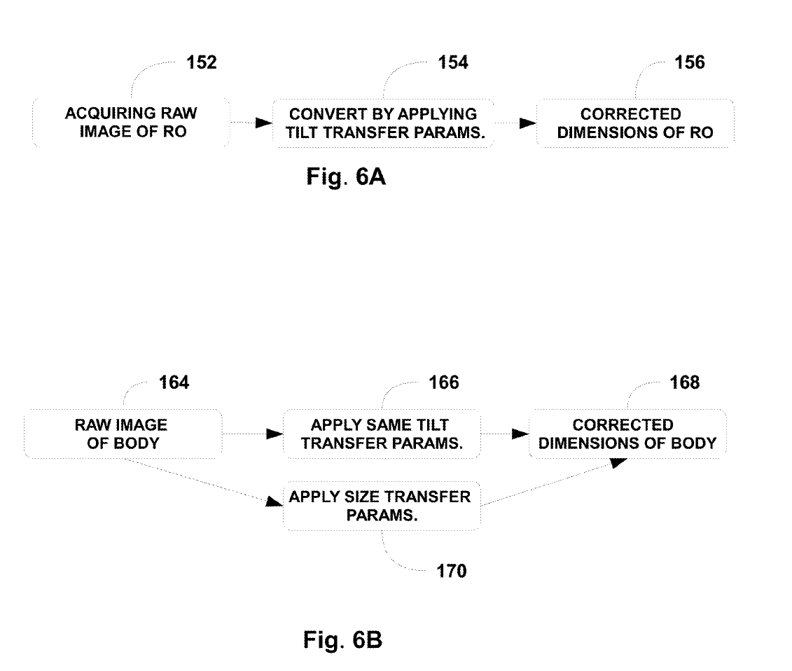

Once the tilt parameters at each axis are calculated, the image obtained by the camera of the IMCS can be corrected for real world dimensions by applying the geometrical corrections obtained by correcting the apparent image geometry to a rectified image geometry (which is in fact the real world dimensions) by applying the transfer parameters, for each axis. Referring to FIGS. 6A-B, one can use the same transfer parameters to apply to the raw image of the body of the buyer or of images of articles at the buyers side. As can be seen in FIG. 6A, The apparent image of the RO acquired by the IMCS at step 152, undergoes conversion at step for all axes at step 154 to obtain real world dimensions of RO as if it was positioned upright and completely leveled. At FIG. 6B, the raw image of the body or a garment of the buyer obtained at step 164 are applied thereon size transfer parameters as used for the RO at step 166 and then corrected dimensions of the body are obtained at step 168 using the size transfer parameters, such as the ratio between the screen and the waist, together with the size transfer parameters resulting from the tilt angles at step 170. Nevertheless, using tilt angle from the tilt sensor is not the only angle correction option available. Raw image can be corrected for inclination using a combination of autofocus values, and optical aperture features available from the maker of the camera/communications device.

Other algebraic methods can be used to obtain transfer parameters and correction parameters but the fundamental concept is that of unknowns (real world dimensions of body and/or garments) can be computed from known aspect parameters (tilt parameters, acquired image of both known object and body at once).

Matching Garments and or Accessories with Buyer Dimensions

The reseller, or service provider as discussed, after having accumulated dimensional data for a stock (inventory) is able to approach buyers and offer garments matching services between their dimensional data as derived from a numerical body model or a model based on user garments, and the dimensional data of the stock managed by the service provider side and kept in a database.

Match Map

One way of demonstrating a match between a buyer and existing stock of merchandise is to compare dimensions of a buyer and a garment for example, to compute a map of coincidence between one and the other. Colour coding can be used to describe matching zones. For example: shades of blue for slack, and shades of red for tight, and purple for complete mismatch.

Colour Matching

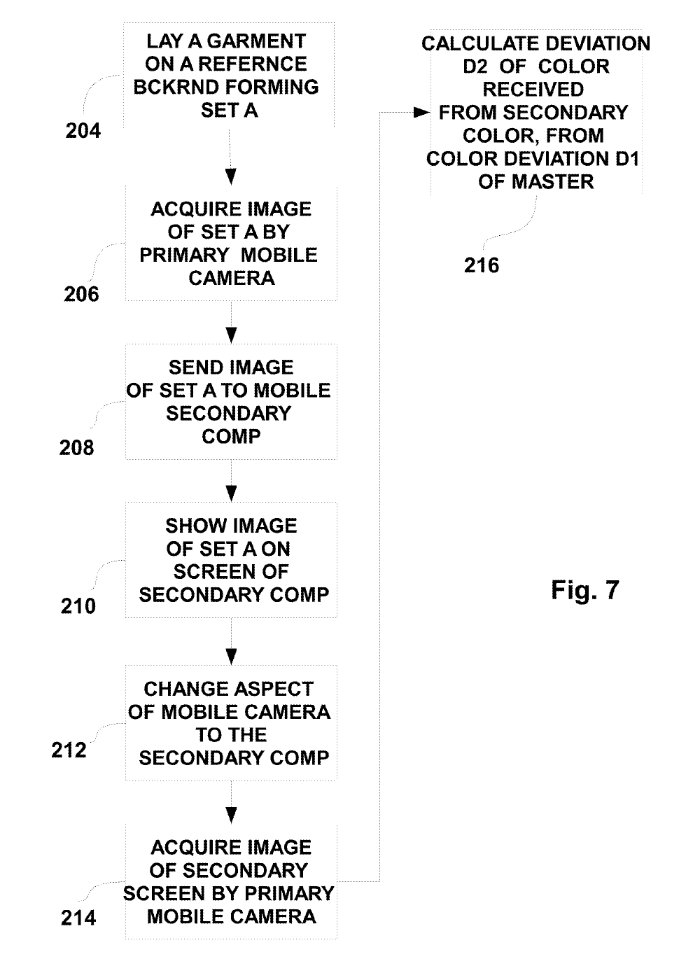

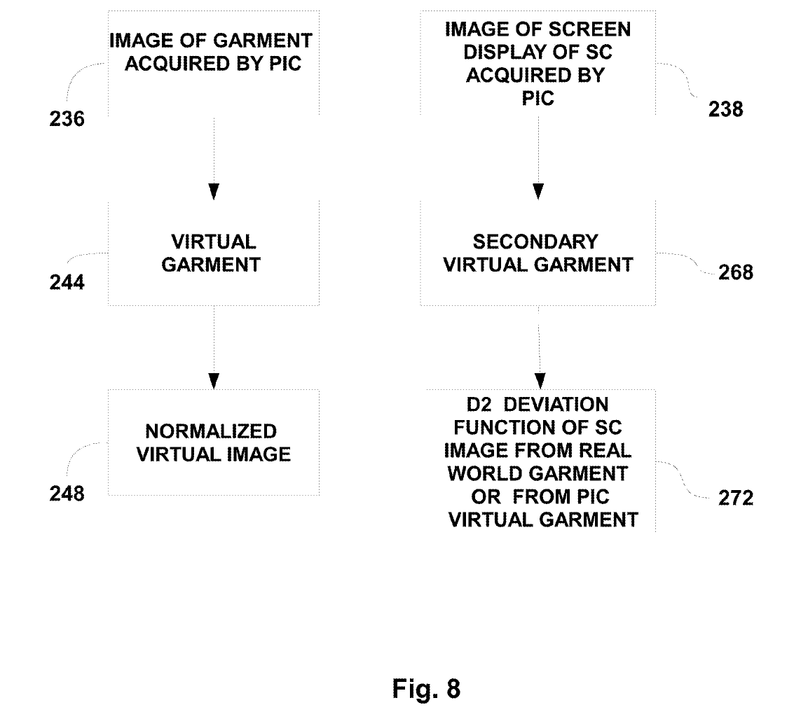

Colour is a very important factor in the choice making due to personal taste usually associated with aesthetic values. A potential customer is likely to be occupied much with sorting of garments based on the colour or assortment of colours which appear on the garment. In accordance with the present invention the SP offers a service of matching colours to a high degree of accuracy. Accordingly, the service provider (SP) collects information regarding the differences between existing makes and models of smart-phones, tablets, or any other imaging devices associated with personal communications apparatuses available on the market. As the SP builds a reference table for each specific make or model of camera and screens he/she uses, when obtaining data from a buyer, the SP is able to transform the data acquired by a specific make/model hardware the characteristics of which are sent to by the buyer, transform the colour data using table the SP possesses to find a high quality match. To enable the SP at the SP side to receive electronic information and be sure to interpret it in real world or in other words human perception terms and vice versa, the SP defines a specific camera as a baseline camera. Then, the SP builds further a reference table, connecting between human perceived colour and numeric color definitions for the specific smart-phone or tablet screen. To explain by way of a practical example how such can be achieved, reference is made now to FIG. 7 The first step (designated step 204) the garment to be inspected is laid over a reference background, in other words, a background colored evenly or in some preregistered combination of known colors. The implementation of a background color reference is not absolutely necessary, and in some embodiments of the invention it may be obviated. For this reason, a wooden parquet floor of irregular colour can be used to lay the garments on for imaging purposes of the garments and/or the background. In step 206 an image of set A is acquired by the camera of associated with a primary imaging computer (PIC), (typically a part of a mobile phone, smart-phone or the like, equivalent or even identical to the IMCS). The optical response curves of this camera are kept by the SP, so that each pixel in the Image has 3 or 4 dimensional properties relating to the colour space of the image they represent, as known in the art. Then, at step 208 the image is sent from the PIC to a secondary computer (SC, equivalent but not necessarily identical to a smart RO) which may be a personal device hand held or not, such as a smart-phone, having a screen. Then, in step 210 the image acquired by the PIC is displayed on the screen of the SC. Further, in step 212 the aspect of the PIC is changed such that the camera mounted on the PIC can acquire an image of the SC screen, accomplished by step 214. Then, at step 216 a deviation is calculated, D2 is the deviation of the image acquired at step 214 from the image acquired at step 206. A block diagram schematizing the relationships between the devices implemented in accordance with the present invention and the indication task assignments is shown in FIG. 8. Image 236 acquired by PIC as explained above, records the pixels relating to the garment and possibly background. PIC also produces an image 238 of the screen display of the SC. The system then produces two virtual garments. Virtual garment 244 is made by subjecting the pixels of image 236 to a transfer function which takes into consideration manufacturers data about the camera sensors, and/or a stored set of reference calibration parameters pertaining to the specific PIC and also optionally the data of the reference background, imaged as described above. A normalized virtual image 248 is produced. On the other hand, Image 238 of the screen display of the SC, is subjected to pixel-wise calibration using a set of calibration parameters specific to the optical features of the SC. The calculations may be carried out anywhere on the PIC or SC or in the network, or in the cloud. Normalized virtual image 268 is produced. Last, a deviation function D2 272 is produced for transferring imagery from SC to real world or to PIC and vice versa.

An additional combination of data on the RO screen is scenario in which the visual data presented on the screen of a smart RO is used as a reference of both size and color, For example the RO screen shows forms such as rectangles of definite size and one or more defined colors, but both forms and colors being controllable.

The SP is to keep data relating to the performance of as many makes of PICs, screen models, and associated cameras as possible, such as of personal communications systems (in which a camera is included) so that a potential buyer would send and or accept data relating to garments and the like from his/her own personal communications device.

Business Structures in which the Invention May be Applied

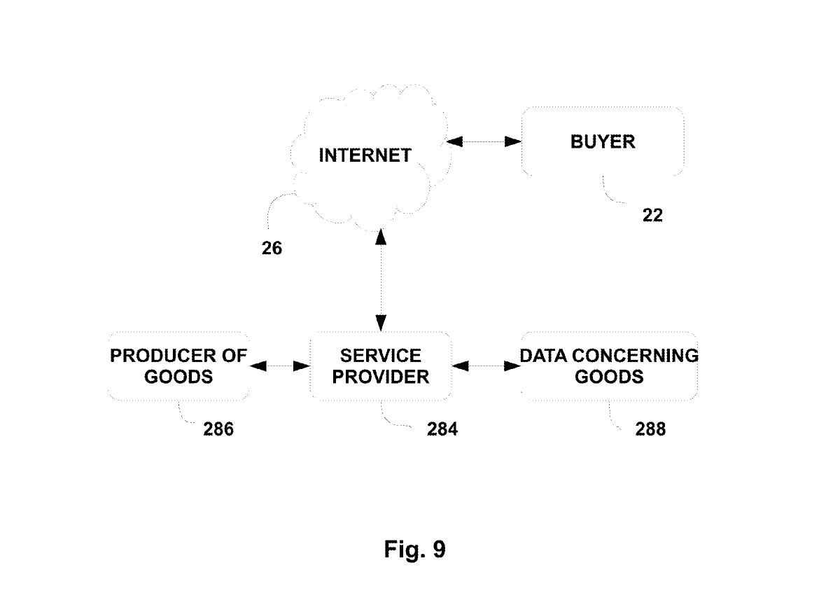

In addition to the connections described in FIG. 1, the implications of the invention lend themselves easily to other business structures of which two will be discussed further. In FIG. 9 a schematic description of a service provider connections are described. Buyer 22 is connected through the Internet 26 or any other network to a service provider (SP) 284 who is a business that collects either goods of producers 286, or data concerning goods 288 and or data concerning buyers and their preferences and or dimensions. The SP in such a case provides services, to both the providers and the buyers. The SP obtains data (body measurements) from the buyers and matches that data with the data about goods which the SP processes. In such a case the SP can do the work of measuring the goods on behalf of providers. This can be done by having human models of known dimensions wear the garments or accessories and the SP through the measuring protocol as described above. Alternatively, the garments are flattened on a table and the RO set next to a garment, laid on the table while the IS could be stabilized on a tripod or held by hand, is given commands to acquire images as required. The service provider may also be defined as a reseller that can collect goods from one or more producers and provide the service of measuring the inventory as described above. In another variation, the producer provides the descriptive pictorial or calculated dimensions to the reseller

Calibration and Aberration Corrections

Prior to invoking a measurement session in accordance with the present invention, some correction measures should or may be applied. Camera optics distortions may be corrected by acquiring in image of well known features and measurements, typically a grid of known cell size. When the image of such a grid is obtained, a transformation function is computed to set the geometry of the output of the camera to fit the grid. Such a corrective procedure may done each time a new session of measurement is to be carried out, or if a specific device is to be used on many occasions, the procedure may be carried out once. In same makes of personal communications devices, optical corrections are made automatically without the user's deliberate intervention.

On occasions, the RO, in its function as a reference object for geometrical properties and or colors, having a screen, may appear to partially blocked by specular reflectance in an image acquired by the IMCS. In such a case not the entire area of the screen of the RO may useful, but some corrections measures can be applied. The screen in such a case of an overflow on some of the pixels, may be divided into squares, larger then a pixel, and each one square is turned to a specific color if it contains parts indicating overflow. In such a case the screen would not be used as a rectangular surface but as an assemblage of squares. Some squares having a hue A, and some having a hue B. Since the squares have known size, such squares, their size and/or number could be used as a reference.

Visual Presentation of Merchandise by a SP

In the following scenario, the potential buyer, goes through a procedure of modeling his/her body or forming a model based on existing collection of clothes. The SP can collect from such a person, typically through the internet, the body model or clothes model or a model of a specific garment and match it with corrected images of producers. One way to do it is to form a display of an image of the item of commerce paced above or near or overlapping the image of the buyer, Moreover, if the buyer seeks to purchase a shirt, and has an image of trousers to send to the SP, the SP may produce a composite display of the complete set, and show it on a web page. For example, if the buyer sends a numeric model, the SP can present it as a silhouette juxtaposing a realistic model of the merchandise. The SP may, in addition to the rectified images, add logos or trademarks of the producers, to help the buyer add aspects to his/her knowledge of the product.

1. A method for exchanging data between a buyer side and a service provider (SP) side wherein a buyer proposes to acquire merchandise associated with at least a garment, and wherein said SP retains access to a variety of pieces of merchandise for which a match between the buyer side and the SP side is to be sought, said method comprising:
first acquiring an at least one image of said at least a garment together with a reference object (RO) having known physical features including at least a colour, said acquiring carried out by an imaging device associated with a mobile communications system terminal;
rectifying said image by using data relating to at least said reference object;
computing scale;
forming a model of said at least a garment, and
sending the model to the other side for using as a base for matching by a recipient of said model.

2. (canceled)

3. (canceled)

4. A method as in claim 1, wherein said model includes data relating to both the geometrical characteristics and to the colour of said garment.

5. (canceled)

6. A method as in claim 1, wherein said physical features include an externally controllable color screen, said color screen usable as a reference for establishing said model.

7. A method as in claim 1, wherein said model includes at least colours and distribution thereof on said at least a garment is laid flat.

8. A method as in claim 1, wherein said reference object has at least one tilt sensor.

9. A method for providing data from a buyer side to a service provider (SP) side wherein a buyer proposes to acquire merchandise associated with at least a garment, and wherein said SP retains access to a variety of pieces of merchandise for which a match between the buyer side and the SP side is to be sought, said method comprising:
first acquiring an image of at least one region of said buyer at said buyer side, together with a reference object by an imaging mobile communications system;
rectifying said image by using data relating to at least said reference object;
computing scale;
forming a model of said at least one region of said buyer, and
sending the model to the other side for using as a base for matching.

10. A method as in claim 2 wherein in order to correct for partial blockage of the screen of said RO, the screen is divided into squares, each one larger than a pixel of said screen, and wherein each such square is assigned a specific color if it contains parts indicating overflow.

11. A system for achieving 3D model of a body of a buyer, said system, comprising:
at least one reference object having an externally controllable feature at the buyer side;
imaging device associated with a mobile communications system terminal for imaging at least said body and said reference object at said buyer side.

12. A method for exchanging colour data of at least a garment between at least a service provider (SP) side and at least one buyer side wherein at said SP side a primary imaging computer (PIC) having associated with a camera, said method comprising:
acquiring an image of at least said garment using said PIC;
sending said acquired image to a secondary computer (SC) of said SP having associated with a camera;
displaying said image on a screen of said SC;
changing the aspect of said screen of said SC to be acquirable by said PIC camera;
said PIC acquiring an image of said screen of said SC;
calculating the deviation images acquired by said specific PIC camera and from the real garment;
using said calculated deviations for keeping data at the SP side regarding the specific CIP make and model.

13. A method as in claim 12 wherein a reference background color is included in said image acquisition of said garments.
